(19) United States
(12) Patent Application Publication
(10) Pub. No.: US 2007/0199618 A1
(43) Pub. Date: Aug. 30, 2007

(54) Method and apparatus for routing angled holes in extruded PVC

(75) Inventor: Stephen R. Estes, South Bend, IN (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SSD CONTROL TECHNOLOGY, INC., South Bend, IN (US)

(21) Appl. No.: 11/651,842

(22) Filed: Jan. 9, 2007

Related U.S. Application Data
(60) Provisional application No. 60/763,958, filed on Jan. 31, 2006.

(51) Int. Cl. B27C 5/00

(52) U.S. Cl. 144/135.2

(57) ABSTRACT

A router may be moved to an angle relative to the workpiece and corresponding to the desired angle of the hole. A plunge actuator may be used to move the router toward the workpiece. The plunge actuator may remain in a generally vertical, or perpendicular position relative to the workpiece. The router may be tilted to the angle of the desired hole. The plunge actuator may move the angled router generally along a line perpendicular to the workpiece to create the desired, angled hole. The router bit may enter the workpiece at an angle to cut the hole. By keeping the plunge actuator in a generally vertical position to route an angled hole, no tilting mechanism may be needed for the plunge actuator, thus reducing the amount of required machinery to cut the hole and improving the adaptability of the router assembly to other equipment.

### RELATED APPLICATIONS

This applications claims priority under 35 U.S.C. Section 119(e) from provisional application Ser. No. 60/763,958, filed Jan. 31, 2006.

### TECHNICAL FIELD

This invention relates to a method and apparatus for routing angled holes in a workpiece, such as, for example, a workpiece made of extruded polyvinyl chloride (PVC).

### BACKGROUND

Polyvinyl tubing is commonly used for many purposes, such as fencing, lawn furniture, etc. Such applications require that the tubing be processed by, for example, forming openings in the side walls of the tubing to accommodate other components of the article being manufactured. This processing is commonly carried out by a template guided router which is used to cut openings in the sides of the tubing. Although the particular embodiment disclosed herein relates to polyvinyl extrusions and the processing of such tubing by cutting openings in the sides of the tubing, the routing device disclosed may also be used in other types of processing, and with other workpieces. The workpieces must be held securely in a predetermined location as the workpiece is being processed. A typical clamp of the type used with this disclosure may be the invention disclosed in U.S. Pat. No. 6,354,581, the entire disclosure of which is hereby incorporated by reference.

Prior art devices for routing holes in PVC include a router and an associated routing bit positioned an angle above the workpiece. To create the angled hole, the prior art router would plunge the routing bit through the workpiece in a straight line along the rotational axis of the router bit. A router carriage would then move the router relative to the workpiece to create a slot or other shaped hole with the router. While conventional devices produce an angled hole, conventional devices typically involve many moving parts and may suffer from one or more deficiencies.

### BRIEF DESCRIPTION OF THE DRAWINGS

FIG. 1 is a fragmentary view in perspective of a process machine for processing PVC workpieces, such as polyvinyl tubing, and incorporating a routing mechanism;

FIG. 2 is an exploded view of the apparatus illustrated in FIG. 1;

FIG. 3 is a cross-sectional view taken substantially along lines 5---5 of FIG. 1;

FIG. 4a is an enlarged fragmentary view of a router employing a prior art method for routing angled holes in PVC;

FIG. 4b is a, enlarged fragmentary view of a router employing a prior art method for routing angled holes in PVC;

FIG. 5 is a flowchart describing a method in accordance with the present invention for routing angled holes in PVC;

FIG. 6a is a detailed view of a router assembly in accordance with the present invention for routing angled holes in PVC;

FIG. 6b is a detailed view of a router assembly in accordance with the present invention employing a method for routing angled holes in PVC;

FIG. 7 is a flowchart describing a method for routing angled holes in PVC;

FIG. 8 is a schematic comparison between an aspect of the prior art method and an aspect of the disclosed method for routing angled holes in PVC;

FIG. 9 is an enlarged perspective view of a prior art router assembly;

FIG. 10 is another perspective view of a prior art router assembly;

FIG. 11 is an enlarged view in perspective of a router assembly in accordance with the present invention; and

FIG. 12 is another enlarged view in perspective of the router assembly of FIG. 11.

### DETAILED DESCRIPTION OF THE PREFERRED EMBODIMENTS

The following description of the disclosed embodiment is not intended to limit the scope of the invention to the precise form or forms detailed herein. Instead, the following description is intended to be illustrative of the principles of the invention so that others may follow its teachings.

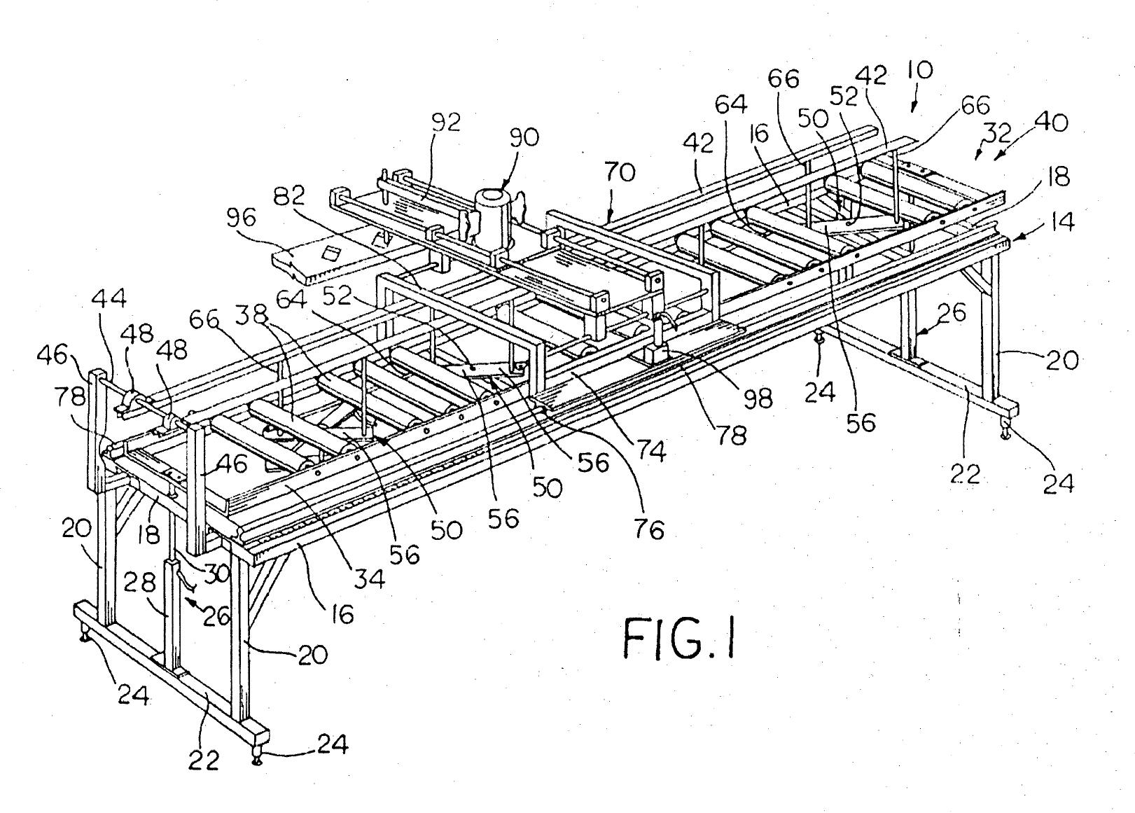

With reference to FIG. 1, a machine generally referred to by the reference numeral 10 may be used, in a preferred environment of use, for cutting openings in the side walls, faces, or any other desired surface of an elongated workpiece 12. The machine 10 includes a fixed support or table generally indicated by the numeral 14, which includes a pair of longitudinal side frame members 16, and a pair of transversely extending upper end frame members 18 which interconnect the side frame members 16. Legs 20 extend downwardly from each end of both side frame members 16. A lower transverse member 22 interconnects the legs 20 on each end of the machine 10. Levelers 24 extend downwardly from each end of both lower transverse members 22. A pair of elevators 26 are installed on each of the lower transverse members 22 and consist of an outer member 28 and an inner member 30 which extends from, and retracts into, the outer member 28. The inner member 30 extends through the corresponding upper end frame member 18. The elevators 26 may be operated manually, such as by a crank, pneumatically, or in any other manner.

A conveyor generally indicated by the numeral 32 is supported along the center line defined by the side frame members 16 by the elevators 26. The conveyor 32 includes a pair of side frame members 34 which extend substantially parallel to the side frame members 16 of the fixed support or table 14. Conveyor 32 further includes transverse end members 36 which are secured to the inner members 30 of elevators 26. Accordingly, by operation of the elevators 26, the conveyor 32 may be raised and lowered relative to the fixed support or table 14. Conventional rollers 38 extend between the side members 34 and are journaled for rotation relative thereto. It will be noted that intermittent gaps 41 are provided between sets of the rollers 38 in which the spacing between rollers is substantially greater than the normal spacing between the rollers 38.

A clamping and holding mechanism is generally indicated by the numeral 40. The clamping and holding mechanism 40 includes all of the features disclosed by U.S. Pat. No. 6,354,581.

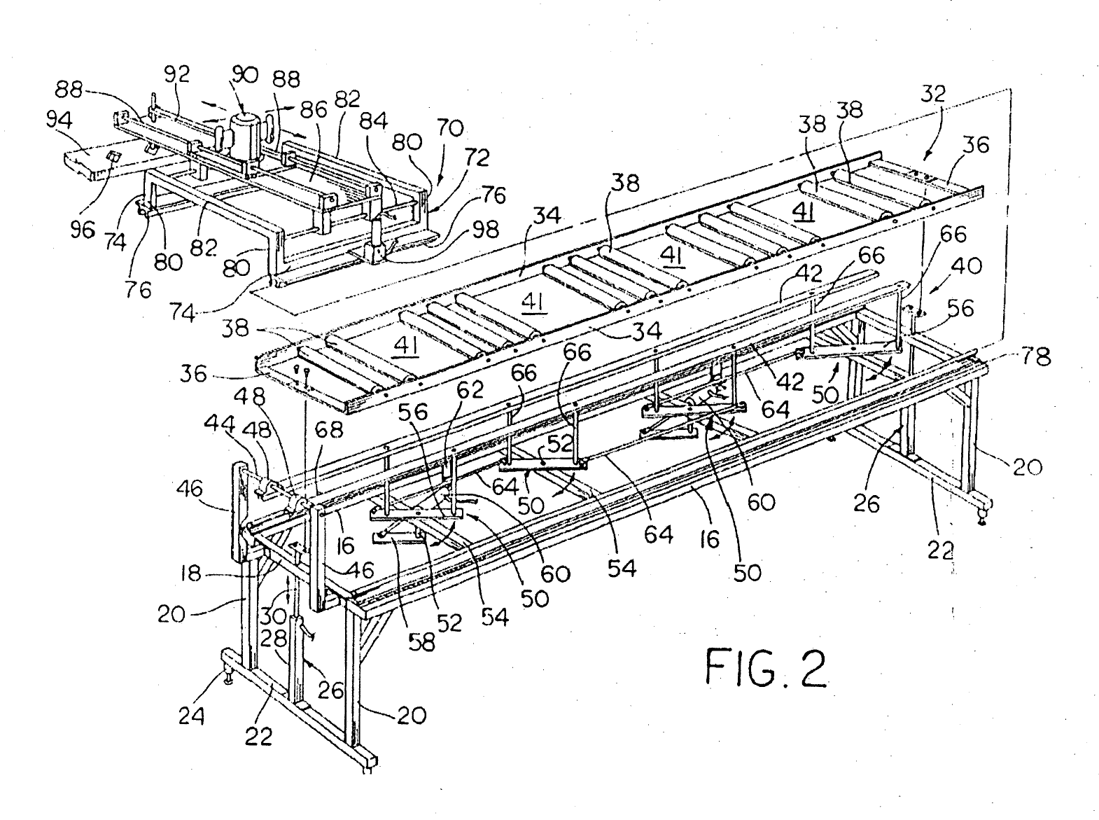

With reference to FIG. 2, a router carriage is generally indicated by the numeral 70. The router carriage 70 includes a bridge 72 having opposite ends 74 which are provided with glides 76 to slidably engage a corresponding one of rails 78 which are mounted on the side frame members 16 and extend upwardly therefrom. Accordingly, the bridge 72 may slide along the side frame members 16 between the ends of the table or fixed support 14. The height of the bridge is established by upwardly extending portions 80 so that transverse portions 82 clear the conveyor 32 and the clamping members 42. Shafts 84 extend between corresponding uprights 80 substantially parallel to the side frame members 16. A router support member 86 is slidably mounted on the shafts 84 for movement longitudinally along the conveyor 32. Router support 86 carries a pair of transversely extending shafts 88 which slidably engage the router 90 to guide the router for movement transverse to the conveyor 32. Accordingly, by sliding relative to the shafts 84 and 88, the router 90 can be positioned at any point along the upper side of the workpiece 12 when the workpiece 12 is installed in the machine 10 and engaged by the clamping members 42. The router 90 is guided by a conventional follower arm 92 which traces on the pattern 96 incorporated within a template 94, in a manner well known to those skilled in the art. Necessary electrical connections to the router 90 are made by electrical wiring extending through a clamp 98 attached to the carriage 70.

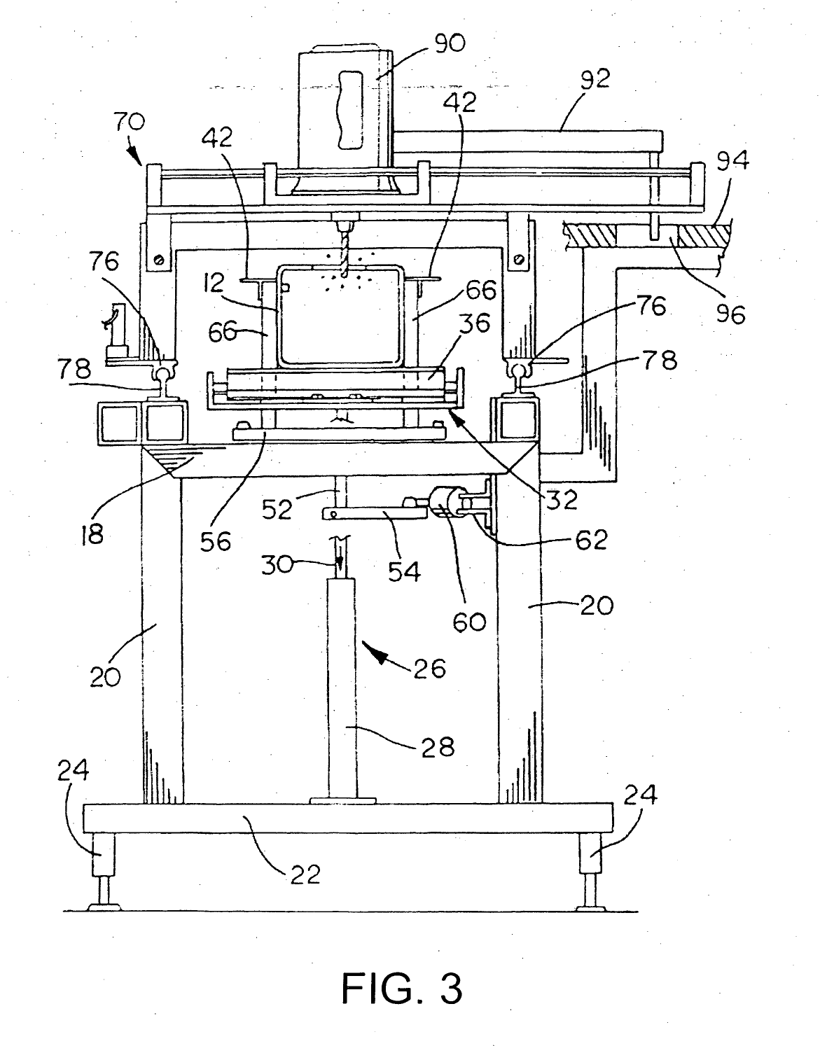

With reference to FIGS. 1 and 2, the workpiece 12 is placed upon the rollers 38 from the right hand end of the machine 10. The workpiece 12 is supported by the rollers 38, and the operator may easily push the workpiece 12 into the machine 10 until the end of the workpiece engages the pin 68 to locate the workpiece relative to the machine 10. The height of the conveyor 32 may be adjusted by operation of the elevators 26 to bring the workpiece 12 to the proper height where it may be kept by the router 90 and in which the end of the workpiece will engage the spring loaded pin 68. For example, in FIG. 3, a relatively large cross section workpiece 12 is being processed, so such that the elevators 26 are used to lower the conveyor 32. After the workpiece has been installed in the machine 10, pneumatic actuators 60 are operated to activate the clamping mechanism of U.S. Pat. No. 6,354,581. The work piece will be moved transversely as the clamping members 42 close against opposite sides of the workpiece, thereby aligning the center line of the workpiece along the center line of the machine 10.

Processing of the workpiece using the router 90 to create angled holes may then begin. The carriage 70 is moved along the tracks 78 along the template 96, which extends along the side of the machine. After the auger 92 is installed in the apertures 96 defined in the template 94, operation of the router may be initiated to cut the desired angled holes in the workpiece.

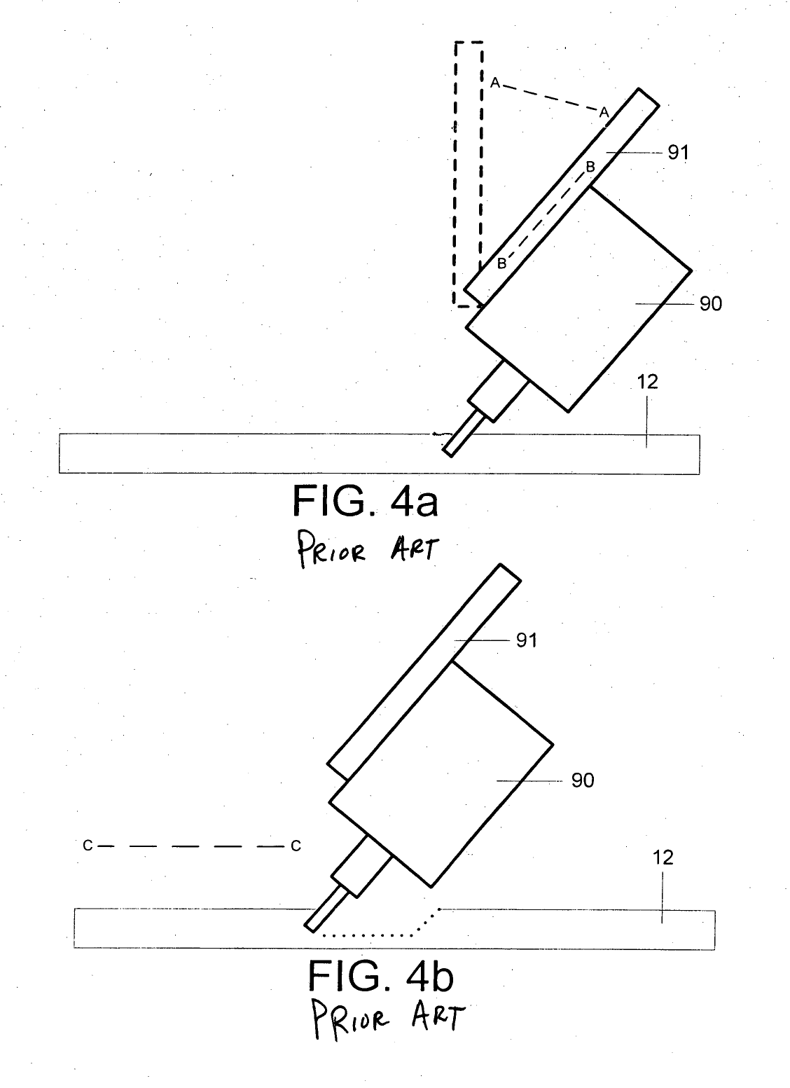

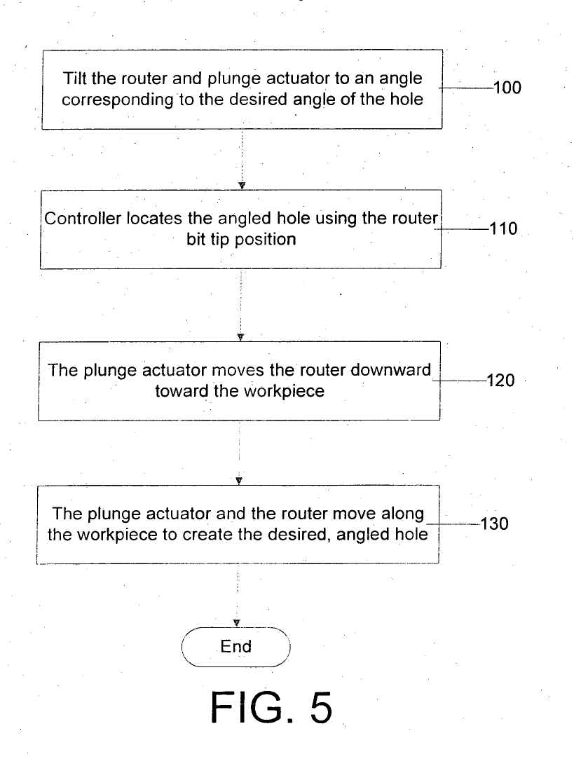

With reference to FIG. 4a and FIG. 5, at block 100, the router 90 and plunge actuator 91 may be moved to an angle relative to the workpiece 12 and corresponding to the desired angle of the hole. As the plunge actuator 91 may be moved generally along line A-A to an angled position relative to the workpiece 12, the router 90 may also come to an angled position relative to the workpiece 12. As shown in FIG. 4a, the router bit tip may correspond to a beginning or ending edge of the angled hole. A controller system may derive the placement of the angled hole on the workpiece from the location of the router bit tip relative to the workpiece. The controller system could rely on the router bit tip entering the workpiece at an edge of an angled hole and could use that information to place the angled hole on the workpiece. At block 110, the controller may locate the angled hole on the workpiece by using the position of the router bit tip. At block 120, the plunge actuator 91 may be used to move the router 90 downward toward the workpiece 12 generally along the line B-B.

With reference to FIG. 4b and FIG. 5, at block 130, the plunge actuator 91 and the router 90 may move along the workpiece 12 generally along the line C-C within the router carriage 70 to create the desired, angled hole.

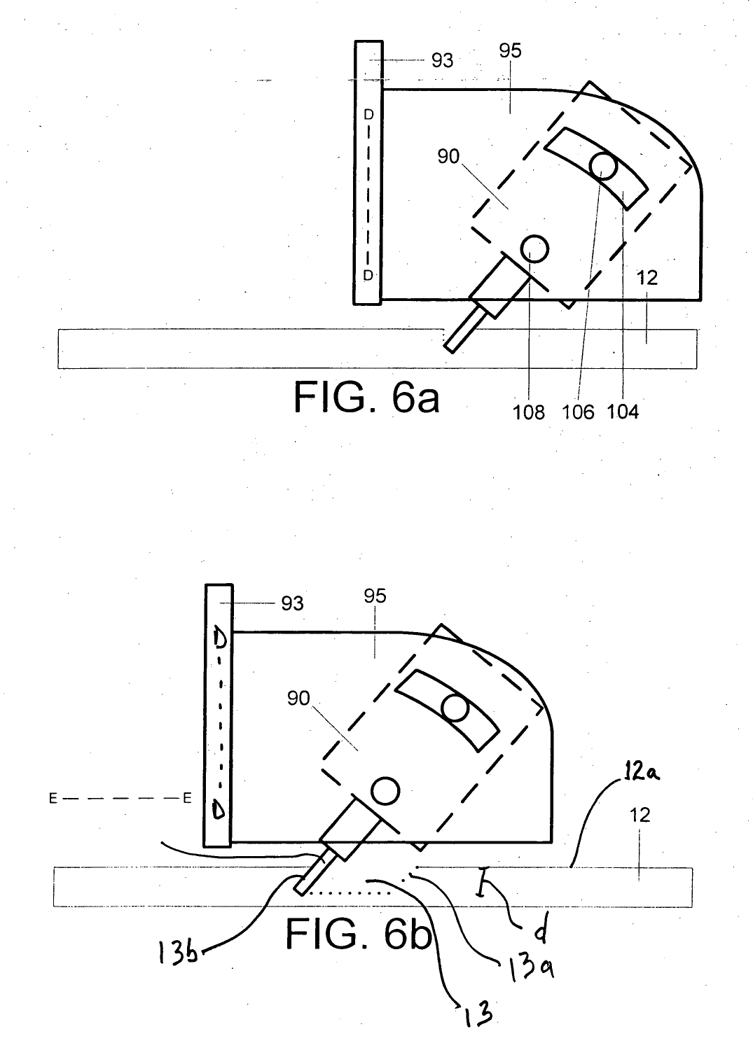

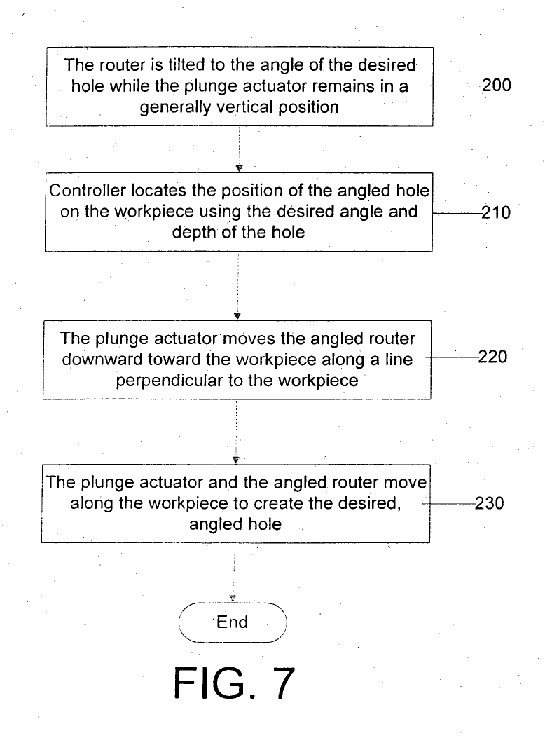

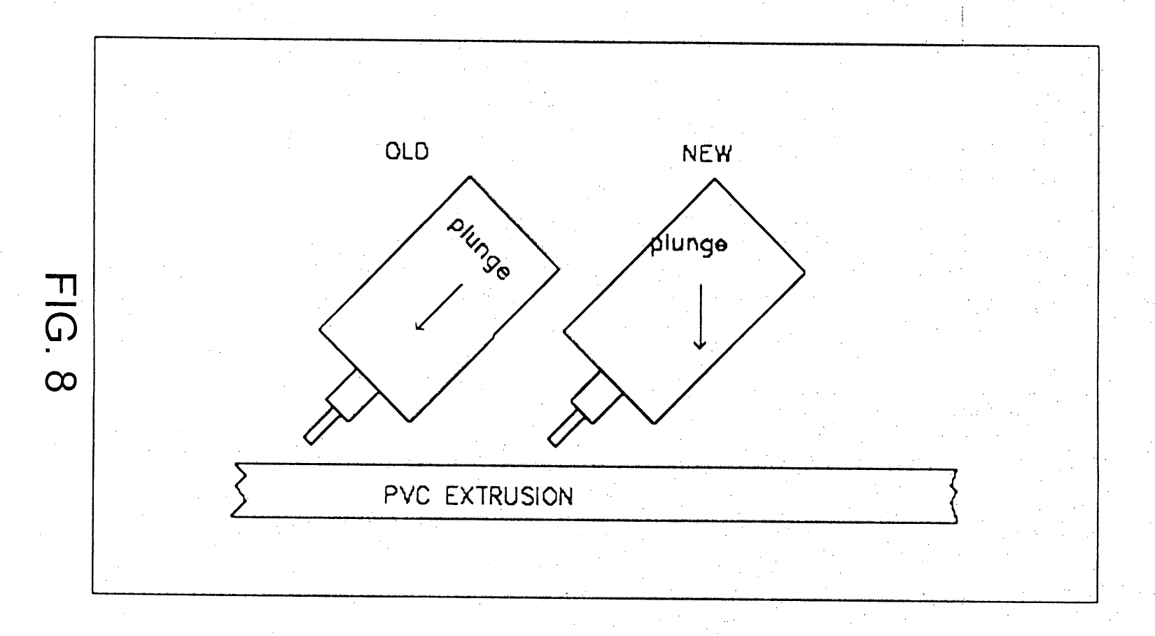

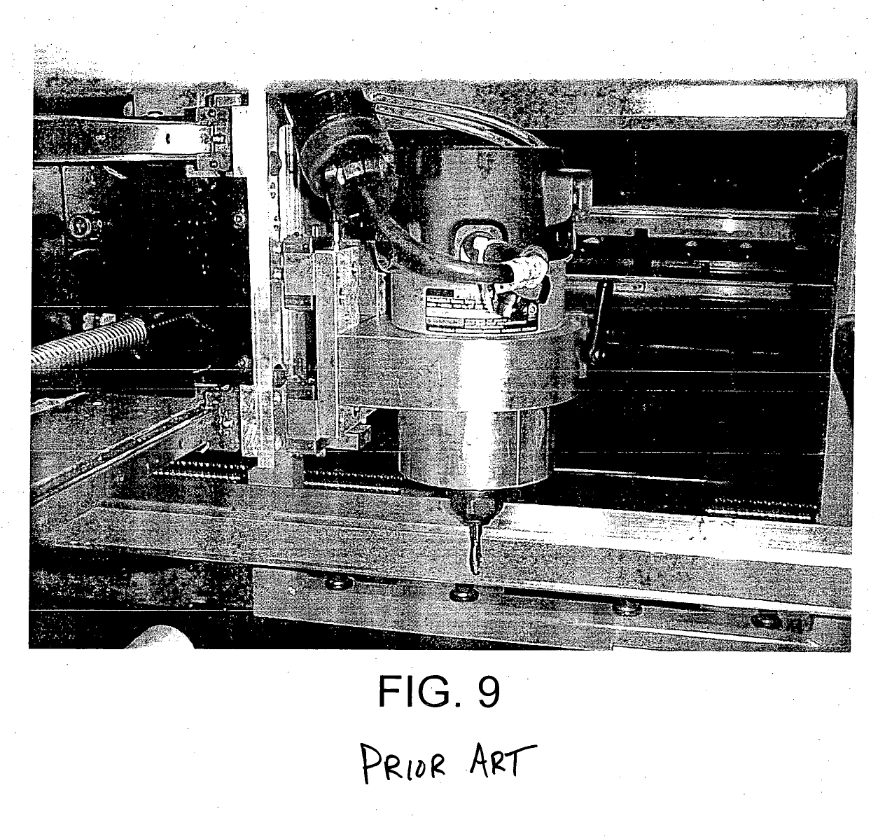

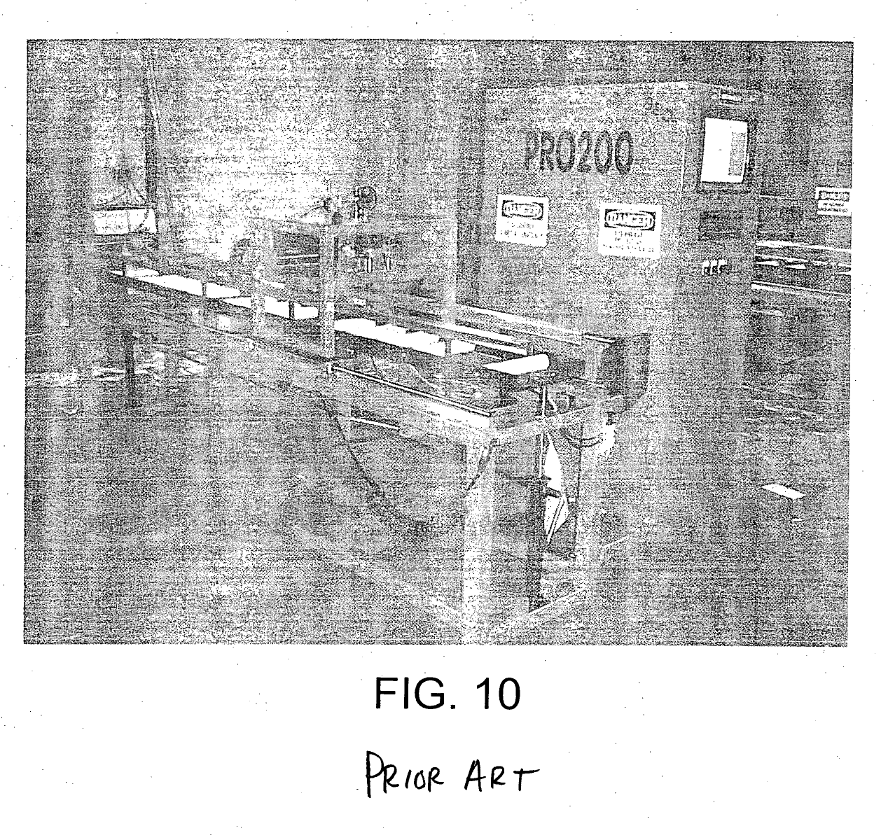

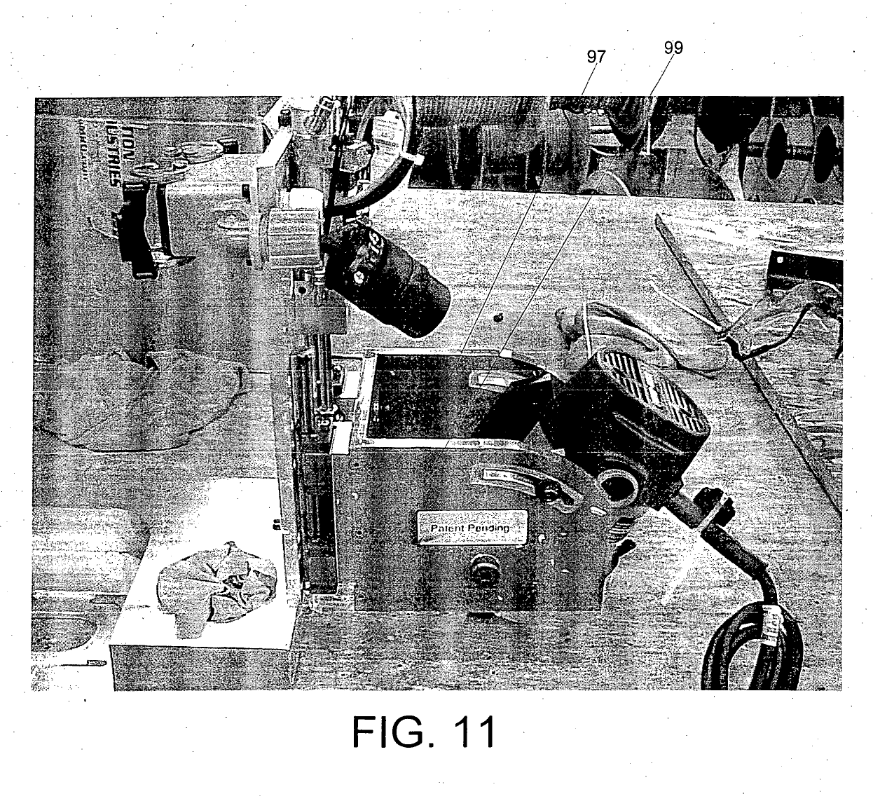

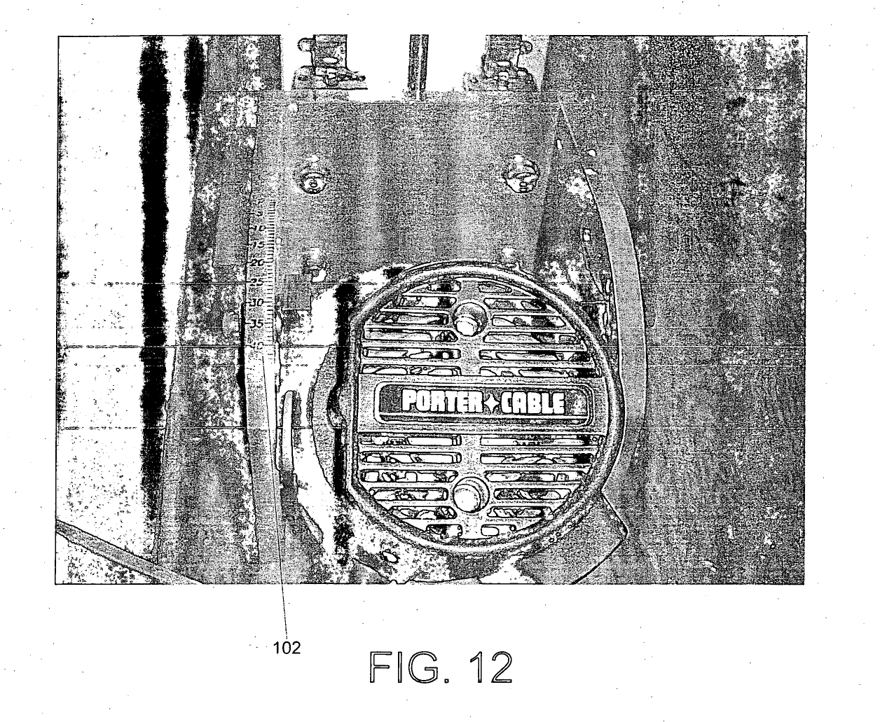

With reference to FIG. 6a and FIG. 7, an apparatus and method for routing angled holes 13 in a workpiece 12 in accordance with a disclosed example of the present invention is illustrated. In accordance with the disclosed example, the plunge actuator 93 can be kept in a generally vertical position while routing an angled hole, as shown in FIGS. 6a and 6b. Thus, no tilting mechanism may be needed for changing the angle of the plunge actuator 93. Thus, the amount of machinery required in order to cut an angled hole is reduced, which may improve the adaptability of the router assembly to other equipment. In the method outlined in FIG. 7, at block 200, the plunge actuator 93 may remain in a generally vertical position, disposed perpendicular relative to the face or surface 12a on the workpiece 12 that will receive the angled hole. The router 90 may be tilted to the angle of the desired hole within a router mounting bracket 95 attached to the plunge actuator 93. The router mounting bracket 95 may have a pair of side plates (FIG. 11) 97, 99. The side plates 97, 99 may each have router mounting holes (FIG. 6a) which may be in communication with a pivot pin 108 and a sliding pin 106. The pivot pin 108 and sliding pin 106 may mount the router 90 between the side plates 97, 99. The sliding pin 106 may mount the router 90 within an arc-shaped slot 104. While the pivot pin 108 holds one end of the router 90 in place, the sliding pin 106 may move within the arc-shaped slot 104 to change the angle of the router 90 within the bracket side plates 97, 99. The sliding pin 106 may include a securing bolt at each end (FIG. 11) for fixing the angle of the router relative to the bracket side plates. A scale (FIG. 12) 102 may provide a guide for the desired angle of the router 90.

As shown in FIG. 6a and FIG. 6b, the router bit tip does not correspond to a beginning edge or ending edge of the angled hole 13, as in the method associated with FIGS. 4a and 4b. Rather, a point on the shaft relative to the depth of the desired hole in the workpiece 12 will correspond to a beginning edge 13a of the angled hole. A controller system may precisely locate an angled hole by compensating for the angled position of the router bit as it enters the workpiece. The controller system corresponding to the method of FIGS. 6a, 6b, and 7 may decide the placement of the angled hole on or into a surface 12a of the workpiece 12 from a point on the angled router bit relative to the desired plunge or depth d of the hole. Using the desired depth and angle of the angled hole, at block 210, the controller system may accurately locate the angled hole on the workpiece 12. At block 220, the plunge actuator 93 may then move the router mounting bracket 95 containing the angled router 90 generally along the plunge line or plunge direction D-D to a desired plunge depth d. The plunge actuator 93 may be any type of suitable linear actuator of the type that is commercially available from a variety of sources, such as a BIMBA actuator.

With reference to FIG. 6b and FIG. 7, at block 230, the router mounting bracket 95 and angled router 90 may be moved generally along the line E-E within the router carriage 70 to create the desired angled hole 13, starting at the beginning edge 13a and terminating at the ending edge 13b.

Those skilled in the art will appreciate that, although the teachings of the invention have been illustrated in connection with certain embodiments, there is no intent to limit the invention to such embodiments. On the contrary, the intention of this application is to cover all modifications and embodiments fairly falling within the scope of the appended claims either literally or under the doctrine of equivalents.

What is claimed:

1. A method for creating an angled hole in a face of a workpiece, the method comprising the steps of:
providing an assembly to hold a router adapted to receive a router bit, the assembly arranged to hold the router at a desired angle tilted relative to the face;
determining a desired location of the hole on the face;
determining a plunge depth; and
moving the router toward the face in a direction perpendicular relative to the face to the plunge depth to locate the router bit in a position to cut the angled hole at the desired location and the desired plunge depth.

2. The method of claim 1, wherein determining the desired location further comprises determining a beginning edge and an ending edge of the angled hole from a depth of the router bit within the workpiece.

3. The method of claim 2, wherein the depth of the router bit within the workpiece corresponds to a portion of a length of the router bit.

4. The method of claim 1, wherein determining the desired location further comprises calculating a location of a tip of the router bit based on the bit length and the desired angle.

5. The method of claim 4, wherein the assembly is arranged to hold the router at a maximum angle and a minimum angle.

6. The method of claim 1, wherein the workpiece comprises a polymer of vinyl chloride.

7. An apparatus for creating an angled hole in a face of a workpiece, the apparatus comprising:
a router arranged to receive a router bit;
a router mounting bracket;
the router mounted to the mounting bracket by a pivot pin disposed at a pivot axis and a sliding pin disposed in an arcuate slot;
a fixing bolt arranged to secure the router at a desired angle relative to the mounting bracket; and
a plunge actuator operatively coupled to the mounting bracket and arranged to move the mounting bracket in a plunge direction perpendicular relative to the face of the workpiece.

8. The apparatus of claim 7, wherein the arcuate slot is sized to permit the desired angle to be adjusted from a maximum of 90°.

9. The apparatus of claim 7, wherein the mounting bracket includes a pair of spaced apart side plates.

10. The apparatus of claim 9, wherein each side plate includes a pivot hole and an arcuate slot.

11. The apparatus of claim 7, wherein the workpiece comprises a polymer of vinyl chloride.

12. A method for routing a slot in a workpiece, the slot having a beginning angled side and an ending angled side, the method comprising:
mounting a router between a pair of opposing brackets, the router including a bit;
providing a pivot assembly to permit the router to tilt relative to the brackets and permit the router to be fixed at a desired angle relative to the brackets;
mounting the brackets to a plunge actuator to permit movement of the brackets toward the workpiece in a plunge direction generally perpendicular to a face of the workpiece;
plunging the bit into the workpiece; and
moving the brackets relative to the workpiece in a direction parallel to a longitudinal axis of the workpiece to cut a slot between the beginning angled side and the ending angled side.

13. The method of claim 12, wherein the pivot assembly comprises a pivot pin and a sliding pin, the sliding pin disposed in an arcuate slot, and including the step of determining a desired angle.

14. The method of claim 13, wherein each of the brackets includes a pivot hole sized to receive an end of the pivot pin.

15. The method of claim 12, wherein plunging the bit into the workpiece comprises plunging the bit into the workpiece to a depth corresponding to a length of the router bit.

16. The method of claim 12, further comprising compensating for the router bit location to locate the angled hole in the workpiece.

17. The method of claim 16, wherein compensating for the router bit location to locate the angled hole in the workpiece comprises compensating for a location of a tip of the router bit and a router bit length.

18. The method of claim 12, wherein a location of the beginning angled side and the ending angled side of the angled hole in the workpiece corresponds to a depth of the router bit within the workpiece.

19. The method of claim 12, wherein the of the beginning angled side and the ending angled side of the angled hole in the workpiece are generally parallel.

20. The method of claim 12, wherein the workpiece comprises a polymer of vinyl chloride.
